(19) United States
(12) Patent Application Publication
(10) Pub. No.: US 2007/0164080 A1
(43) Pub. Date: Jul. 19, 2007

(54) Mounting system and method for mounting objects

(76) Inventor: Bradley James Young, Cumming, GA (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/332,524

(22) Filed: Jan. 13, 2006

(51) Int. Cl. A47J 36/02

(52) U.S. Cl. 228/101

(57) ABSTRACT

A mounting system and method for mounting objects are provided. The mounting system includes a mounting component having an angled engagement portion configured to an engage an object and a leveling component having an angled portion configured to abuttingly engage the angled engagement portion of the mounting component. The leveling component also includes a leveling device.

### BACKGROUND OF THE INVENTION

This invention relates generally to mounting systems, and more particularly, to a system for mounting objects in a level orientation.

Mounting systems are known for mounting objects, such as shelves, picture frames, mirrors, etc. to a wall, door or other support structure. When mounting an object, one or more factors such as the location, positioning, orientation, etc. of the object are typically evaluated to determine a desirable or acceptable location. Often the aesthetic appearance of the mounted object is very important. For example, it is often important that a picture or shelf mounted to a wall is level. This may not only be desirable, but also necessary for the proper functioning of the object (e.g., level shelf to support items thereon).

When attempting to mount an object to a support structure in a level orientation there are many known methods. One method is to simply eyeball the object and mounting components. This method may work well for mounting picture frames having hanging wires that allow a substantial amount of adjustment after hanging, but often will not work satisfactorily for other applications. For example, the eyeballing technique may not work well when mounting picture frames without hanging wires and mounting shelves or other objects requiring a more substantial mounting bracket or support.

When attempting to mount an object that requires a bracket or other structure and/or that requires level connection with, for example, a wall, different methods are known. For example, it is know to provide a keyhole type mounting system for shelves. However, in these systems a level or other measuring device, such as a tape measure, must be used to ensure that the nails are aligned on the wall. Additionally, this alignment or measurement requires center-to-center measurement of the keyholes and top of keyhole to top of shelf measurement. All these measurements must take into account the size of the anchor screw (e.g., radius of anchor screw). This mounting process is tedious and time consuming. Also, it is often difficult to mount the shelf at the desired height and to ensure a level orientation. The nails or screws may have to be repositioned because of improper alignment with the keyholes. This may result, for example, from lateral shifting of the drill bit or anchor during installation. A further issue also can arise due to the protruding hardware on the back of the shelf that requires the anchor screws to extend far enough out of the wall to insert the screw head into the keyhole. Often when trying to attach the shelf to the nails, the back of the shelf will push the nail into the wall such that attachment is not possible. Thus, not only is this a difficult and tedious process, but flush mounting is often not possible.

It is also known to incorporate alignment mechanisms into the mounting systems, and more particularly, in connection with the mounting brackets. For example, it is known to integrate a bubble or spirit level with the mounting bracket. Although this facilitates level mounting of the bracket to, for example, a wall, the addition of a level adds cost and complexity to the manufacturing process. Further, the level typically cannot be reused. Additionally, the size of the level or the size of the structure in the bracket for holding the level may result in having to provide additional space in the back of the shelf to accommodate this level or structure. As a result, these brackets may not be able to be used for small shelf applications. Further, when using these brackets it is difficult and/or time consuming to determine the final mounted height of the shelf, picture, etc.

Thus, known systems for mounting objects such as picture frames and shelves to a wall often is a time consuming installation process that requires numerous adjustments or remounting of the hardware. Additionally, systems that provide improved alignment add complexity and cost to the overall design.

### BRIEF DESCRIPTION OF THE INVENTION

In an exemplary embodiment, a mounting system is provided that includes a mounting component having an angled engagement portion configured to an engage an object and a leveling component having an angled portion configured to abuttingly engage the angled engagement portion of the mounting component. The leveling component also includes a leveling device.

In another exemplary embodiment, a mounting system is provided that includes a mounting component having an engagement portion configured to engage an object and a leveling component having an alignment opening configured to align the leveling component with a mounting position for the object. The leveling component includes a leveling device and is configured to engage the mounting component in an abutting arrangement.

In yet another exemplary embodiment, a method for mounting an object to a support structure is provided. The method includes configuring a leveling component and a mounting component for complementary engagement and providing an alignment opening in the leveling component to align the leveling component with a mounting position identified on the support structure. The mounting position identifies the location to mount the object with the mounting component.

### BRIEF DESCRIPTION OF THE DRAWINGS

FIG. 1 is a perspective view of a mounting component constructed in accordance with an embodiment of the invention.

FIG. 2 is a side elevation view of the mounting component of FIG. 1.

FIG. 3 is a perspective view of a leveling component constructed in accordance with an embodiment of the invention.

FIG. 4 is a side elevation view of the leveling component of FIG. 3.

FIG. 5 is a front elevation view of the leveling component of FIG. 3.

FIG. 6 is a perspective view illustrating a mounting process in accordance with an embodiment of the invention using the mounting component of FIG. 1 and the leveling component of FIG. 3.

FIG. 7 is a perspective view illustrating the mounting component of FIG. 1 and the leveling component of FIG. 3 in abutting engagement during a mounting process in accordance with an embodiment of the invention.

FIG. 8 is a front plant of view illustrating an alignment of the mounting component of FIG. 1 and the leveling component of FIG. 3 during a mounting process in accordance with an embodiment of the invention.

FIG. 9 is a perspective view of a shelf constructed in accordance with an embodiment of the invention.

FIG. 10 is a perspective view of the mounting component of FIG. 1 partially engaged with the shelf of FIG. 9.

FIG. 11 is a perspective view of the mounting component of FIG. 1 engaged with the shelf of FIG. 9.

FIG. 12 is a perspective view of the shelf of FIG. 9 mounted to a support structure using the mounting component of FIG. 1 and the leveling component of FIG. 3 in accordance with an embodiment of the invention.

### DETAILED DESCRIPTION OF THE INVENTION

Various embodiments of the invention provide a system for mounting an object to a support structure. For example, the various embodiments provide a system for mounting a shelf, picture frame, etc. to a wall. It should be noted that although the various embodiments may be described in connection with mounting a specific object, and more particularly, a shelf (e.g., a decorative shelf) to a wall, other objects and mounting configurations are contemplated. For example, the various embodiments may be implemented in connection with mounting different objects, such as mirrors, picture frames, fixtures, sconces, etc., on different support structures, such as doors, moveable panels, etc.

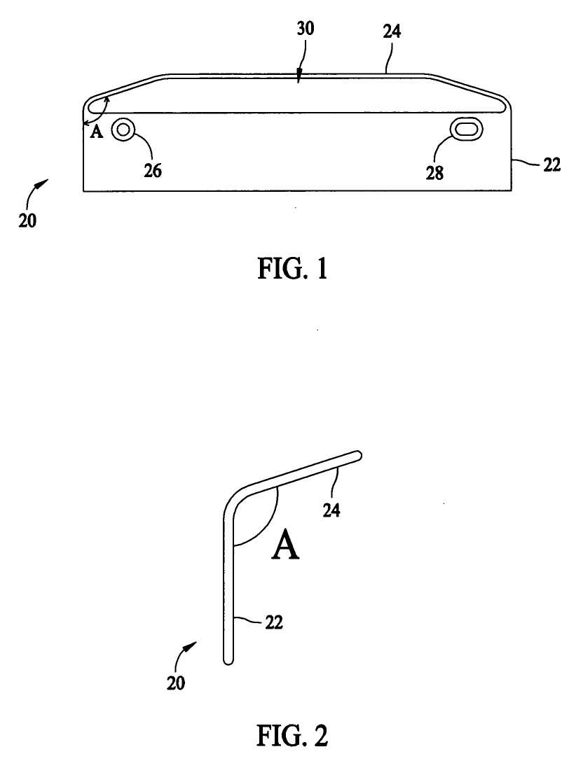

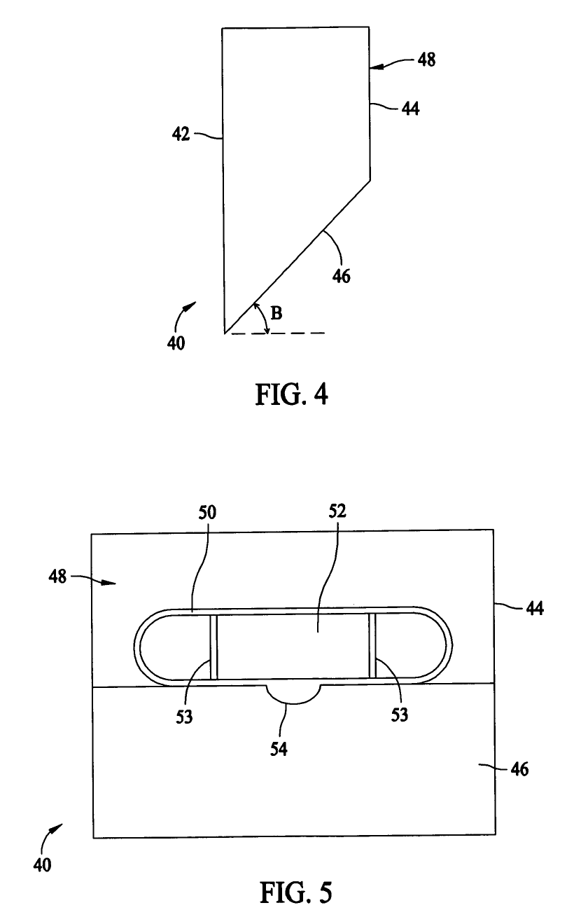

In general, various embodiments provide a system for mounting an object to a support structure in a horizontal or level orientation. In particular, the system includes a mounting component 20 and a leveling component 40 as shown in FIGS. 1 through 5. The mounting component 20, as shown in FIGS. 1 and 2, is formed having a base portion 22 and an engagement portion 24, and may be configured, for example, as a bracket. The base portion 22 is generally planar and includes a first opening 26 and a second opening 28. In an exemplary embodiment, the first opening 26 is a generally circular hole and the second opening 28 is a generally slotted or elongated hole. In the various embodiments, the first and second openings 26 and 28 may be provided in a countersunk configuration such that a nail, screw or other fastener or securing device is flush with the surface of the base portion 22 when mounted.

The engagement portion 24 extends from a top of the base portion 22 at an angle A. The angle A may be varied between about zero degrees and about 180 degrees, for example, based on the configuration of the object to be supported by the mounting component. In particular, the angle is provided such that the engagement portion 24 engages the object to be mounted, for example, extends into a receiving portion of the object. The engagement portion 24 also is configured in a shape complementary to the receiving portion of the object to be mounted (e.g., engaged and supported) by the mounting component 20. For example, as shown in FIG. 2, the sides and corners of the engagement portion 24 may be rounded. The engagement portion 24 also includes an alignment indicator 30 generally located at a top middle portion of the engagement portion 24, and which is shown in FIG. 1 as a notched portion. The alignment indicator 30 generally marks the center or middle of the mounting component 20. However, it should be noted that the alignment indicator 30 may any type of marker or other member indicating an alignment point of the engagement portion 24, for example, a colored mark, etc.

In the various embodiments the base portion 22 and the engagement portion 24 may be formed as a single unitary piece. Further, different types of materials may be used to construct the mounting component 20 including, for example, plastic, metal, rubber, wood, a composite material, a combination thereof, among others.

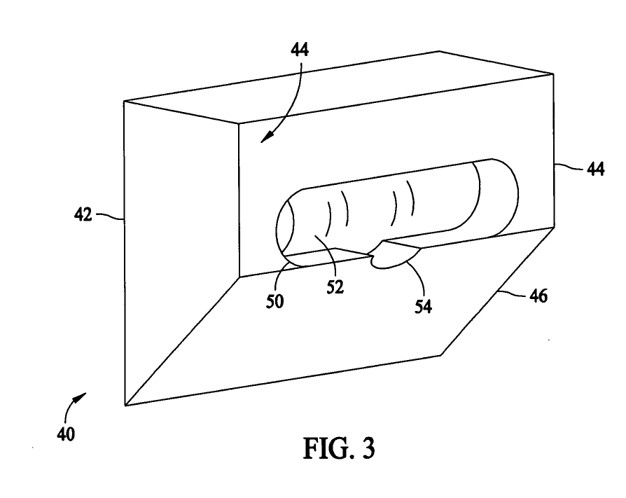

The leveling component 40 as shown in FIGS. 3 through 6 includes a body 42 having an upper portion 44 and a lower portion 46. In an exemplary embodiment, the body 42 is formed having a generally trapezoidal cross-section. In particular, the upper portion 42 includes a generally planar face 48 having an opening 50 therein. The opening 50 is configured to receive a leveling device 52, which may be, for example, a spirit level or bubble level as is known. The leveling device 52 may include markings 53 as shown in FIG. 5 to facilitate orienting the leveling component 40 in a generally level position. The leveling device 52 may be permanently secured within the opening 50 or may be removably secured therein. The opening 50 extends into the upper portion 44 of the body 42 such that the leveling device 52 is entirely within the opening 50. Alternatively, the opening 50 may be configured such that a portion of the leveling device 52 is outside the opening 50 extending beyond the planar face 48.

The lower portion 46 is formed having an angled profile extending from the front of the leveling component 40 at a lower end of the upper portion 44 to the back of the leveling component 40. The angle B of the lower portion 46 is configured to be complementary with the angle of the engagement portion 24 of the mounting component 20 (both shown in FIGS. 1 and 2). The complementary arrangement provides the angled face of the engagement portion 24 of the mounting component 20 in abutting engagement with the lower portion 46 of the leveling component 40 when the mounting component 20 is in contact with the leveling component 40 as described in more detail herein.

The leveling component 40 also includes an alignment opening 54 that extends through the entire body 42, for example, defining a channel or passage through the body 42. The alignment opening 54 may be formed in the lower portion 46, the upper portion 44 or both and is sized such that an individual can see through the alignment opening 54. In an exemplary embodiment, the alignment opening 54 is configured as a half circle extending from the lower portion 46 to the bottom of the upper portion 44. In this embodiment, the alignment opening 54 extends perpendicular to the opening 50 and along an axis generally centered between the sides of the leveling component 40.

The leveling component 40 may be formed as a single unitary piece. Additionally, the leveling component 40 may be constructed of any material including, for example, plastic, metal, rubber, wood, a composite material, a combination thereof, among others.

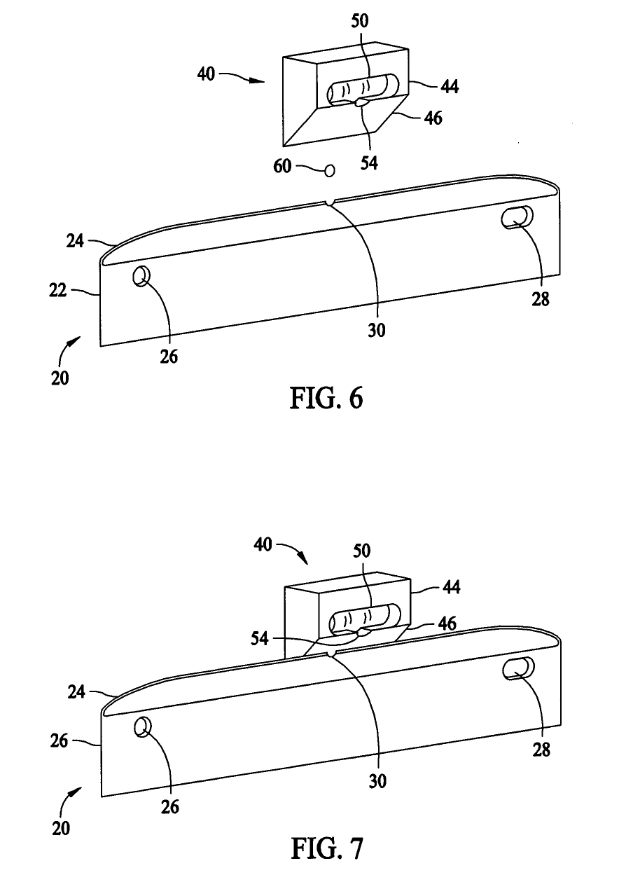

In operation, the leveling component 40 is used to align and orient the mounting component 20 to a support structure, for example, a wall (not shown), as shown in FIGS. 6 through 9. In various embodiments, a desired or required location for mounting an object, for example, a shelf, is determined or selected. This location is then identified with a mark 60. This mark 60 may be made, for example, using a pen, pencil or other marking device and the positioning of the mark 60 (e.g., colored circular mark) is provided at the desired or require location for mounting the object, which in one exemplary embodiment, is the location of the top of the object to be mounted. For example, in one exemplary embodiment the mark 60 is the position of the desired or required center location for a top of shelf to be supported by the mounting component 20.

Once the mark 60 is made the mounting component 20 is placed on the wall, for example, by a user holding the mounting component 20 against the wall with one hand. The leveling component 40 is placed on the wall above or adjacent the mounting component 20, for example, by a user holding the leveling component 40 above the mounting component 20 with the user's other hand. The leveling component 40 is placed with the angled lower portion 46 facing downward towards the mounting component 20 with the engagement portion 24 of the mounting component 20 facing upward towards the leveling component 40. The leveling component 40 is then moved into abutting engagement with the mounting component 20. Specifically, the angled lower portion 46 of the leveling component 40 is positioned in abutting engagement with the complementary angled engagement portion 24 of the mounting component 20 as shown in FIG. 7.

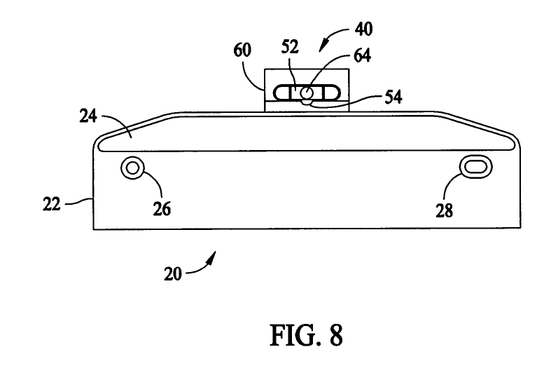

The mounting component 20 and leveling component 40 are then oriented in a generally level position (e.g., horizontally) and aligned with the mark 60. Specifically, as shown in FIG. 8, the leveling component 40 is positioned relative to the mounting component 20 (e.g., moved or positioned) such that the alignment opening 54 of the leveling component 40 is aligned with the alignment indicator 30 of the mounting component 20. The aligned abutting leveling component 40 and mounting component 20 is then positioned on the wall such that the mark 60 is visible through the alignment opening 54.

Thereafter, the abutting leveling component 40 and mounting component 20 are moved and/or positioned (e.g., tilted) such that the leveling device 52 of the leveling component 40 indicates that the leveling component 40 is level, also indicating that the abutting mounting component 20 is also level. For example, and as is known, the leveling component 40 may be titled until a bubble 64 of the leveling device 52 is in the middle of the leveling device 52. As described above other leveling devices may be used. For example, a laser leveling system as is known may be used as part of the leveling component 40. It should be noted that the various steps for aligning and leveling the leveling component 40 and mounting component 20 may be modified as desired or needed. For example, the order of the steps may be changed.

After aligning the abutting leveling component 40 and mounting component 20 with the mark 60 and leveling the abutting leveling component 40 and mounting component 20, anchor or mounting positions are marked, for example, directly through the first and second openings 26 and 28 of the mounting component 20. For example, a marking device such as a pen or pencil may be used to make marks on the wall through the first and second openings 26 and 28 for use in later attaching the mounting device 20 to the wall. The marks may be a circle, “X” or other indication of the location of the first and second openings 26 and 28. Alternatively, nails, screws or other similar securing devices may be attached to the wall. For example, a nail or screw may be driven or screwed directly into the wall through the first and second openings 26 and 28. If marks are made on the wall, then the abutting leveling component 40 and mounting component 20 may be removed, anchors or other supporting devices installed and then the mounting component 20 attached to the anchors and the wall using, for example, screws attached to the anchors through the first and second openings 26 and 28, and tightened to secure the mounting component 20 to the wall.

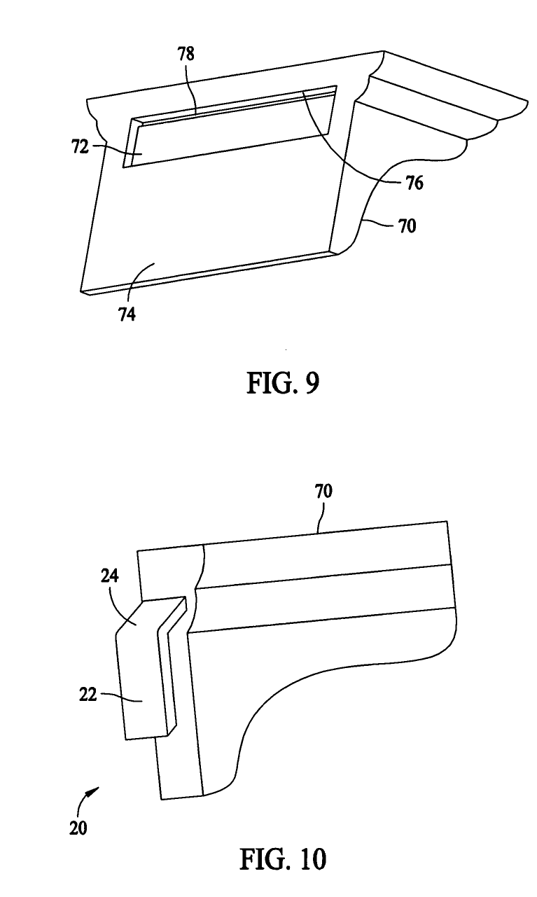

With the mounting component 20 secured in a level orientation to the wall, an object may be connected to and supported by the mounting component 20. For example, a shelf 70, such as a decorative wood shelf, as shown in FIG. 9, may be connected to the mounting component 20, thereby mounting the shelf 70 to the wall. In an exemplary embodiment, the shelf 70 includes a recessed portion 72 (e.g., a rectangular pocket) on a back 74 of the shelf 70. The recessed portion 72 is sized and configured (e.g., shaped) to receive therein the base portion 22 of the mounting component 20 (shown in FIG. 1). At a top 76 of the recessed portion 74 is a slot 78 extending into the shelf 70 at an angle complementary to the angle of the engagement portion 24 of the mounting component 20 and defining a receiving portion for the engagement portion 24. The slot 78 extends into the shelf 70 transversely across the back 74 of the shelf 70 from one side of the recessed portion 72 to an opposite side of the recessed portion 72. The slot 78 is also shaped such that the engagement portion 24 aligns within the slot 78. Essentially, the slot 78 includes an alignment region for aligning the engagement portion 24 therein. For example, the slot 78 may include rounded portions complementary to the rounded sides and corners of the engagement portion 24. This complementary shaped arrangement provides “auto-centering” or “self-centering” when the shelf 70 is engaged with the mounting component 20.

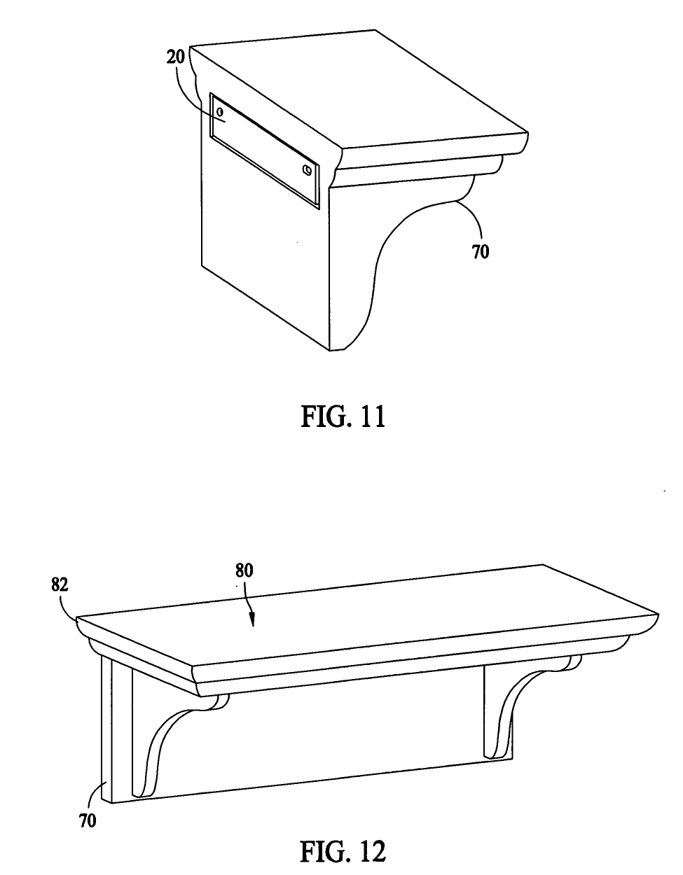

In operation (e.g., installation) as shown in FIGS. 10 and 11, the engagement portion 24 of the mounting component 20 is inserted within the slot 78 of the shelf 70. The shelf 70 is then moved until the engagement portion 24 of the mounting component 20 is within the slot and the base portion 22 is within the recessed portion 72 as shown in FIG. 11. Accordingly, the mounting component 20 engages both the back and the top of the shelf 70 and the engagement portion 24 will align within the slot 78. The shelf 70 also will seat flush against the wall as shown in FIG. 12 and provide a level surface 80, which may be used, for example, to support and/or display items thereon. Additionally, a top 82 of the shelf 70 will be positioned at the level of the mark 60 (shown in FIGS. 6 and 8).

Thus, various embodiments of the invention provide a system for mounting an object, for example, a shelf in a level orientation. The various embodiments allow for alignment and positioning of the object at a desired or required point on a support structure, such as a wall.

While the invention has been described in terms of various specific embodiments, those skilled in the art will recognize that the invention can be practiced with modification within the spirit and scope of the claims.

What is claimed is:

1. A mounting system comprising:
a mounting component having an angled engagement portion configured to an engage an object; and
a leveling component having an angled portion configured to abuttingly engage the angled engagement portion of the mounting component, the leveling component including a leveling device.

2. A mounting system in accordance with claim 1 wherein the engagement portion is configured to align within the object.

3. A mounting system in accordance with claim 1 wherein the mounting component comprises a first opening and a second opening with at least one of the first and second openings being slotted.

4. A mounting system in accordance with claim 1 wherein the engagement portion include an alignment indicator configured to align the leveling component with a center of the mounting component.

5. A mounting system in accordance with claim 1 wherein the leveling component comprises an alignment opening configured to align the leveling component with a mark on a support structure.

6. A mounting system in accordance with claim 5 wherein the alignment opening extends through a body of the leveling component.

7. A mounting system in accordance with claim 5 wherein the mark identifies a position of a top of the object to be connected to the mounting component.

8. A mounting system in accordance with claim 1 wherein the object is at least one of a shelf and a picture frame.

9. A mounting system in accordance with claim 1 wherein the object is a shelf having a slot extending into the shelf, the slot including an alignment region configured to align the angled engagement portion of the mounting component therein.

10. A mounting system in accordance with claim 9 wherein the alignment region is a generally rounded portion complementary to a rounded corner of the angled engagement portion of the mounting component.

11. A mounting system in accordance with claim 1 wherein the object is a shelf having a recessed back portion configured to receive therein a base portion of the mounting component.

12. A mounting system comprising:
a mounting component having an engagement portion configured to engage an object; and
a leveling component having an alignment opening configured to align the leveling component with a mounting position for the object, the leveling component including a leveling device and configured to engage the mounting component in an abutting arrangement.

13. A mounting system in accordance with claim 12 wherein the alignment opening extends through a body of the leveling component to view a mark on a support structure identifying the mounting position for the object.

14. A mounting system in accordance with claim 12 wherein the alignment opening defines a location of an upper edge of the object to be engaged with the mounting component.

15. A mounting system in accordance with claim 12 wherein the mounting component comprises an alignment indicator configured to align the leveling component with a center of the mounting component.

16. A mounting system in accordance with claim 12 wherein the mounting component is configured to self-center with the object.

17. A mounting system in accordance with claim 12 wherein the mounting component comprises at least one slotted opening.

18. A method for mounting an object to a support structure, the method comprising:
configuring a leveling component and a mounting component for complementary engagement; and
providing an alignment opening in the leveling component to align the leveling component with a mounting position identified on the support structure, the mounting position identifying the location to mount the object with the mounting component.

19. A method in accordance with claim 18 further comprising providing at least one slotted opening in the mounting component.

20. A method in accordance with claim 18 further comprising providing an alignment indicator on the mounting component to align the leveling component with a center of the mounting component.
